(19) United States
(12) Patent Application Publication
(10) Pub. No.: US 2005/0152756 A1
(43) Pub. Date: Jul. 14, 2005

(54) Universal pressure drill and srew runner

(76) Inventor: Ronald Howard, Richmond, VA (US)

Correspondence Address: Ronald Howard, 8728 Trent Rd., Richmond, VA, 23235, US

(21) Appl. No.: 10/754,992

(22) Filed: Jan. 12, 2004

(51) Int. Cl. B23B 45/14

(52) U.S. Cl. 408/103

(57) ABSTRACT

An improved portable, electric, hand drill and screw runner with gear mechanism, that when used with an extendable rod and attachments enables the user to drill holes and run screws into various surfaces and from many different angles. When manual force is applied to the lever attached to the gear mechanism, the drill motor is advanced towards the direction of the drilling surface.

### FIELD OF THE INVENTION

This invention relates generally to hand drills and screw runners and more particularly to the improvement of portable power drills and screw runners. Specifically, this invention pertains to improved drill and screw runner motors, that when used in conjunction with the extendable rod and attachments, enables the user to drill and run screws in many different angles and in many different surfaces without the laborious work normally required when the user drills a hole or runs screws into a surface such as concrete, wood, steel, or other hard metals.

### BACKGROUND OF THE INVENTION

There is considerable need in the field of construction work for a drilling apparatus which drills concrete, wood, steel, and other hard metals, as well as runs screws in a manner that is safe, accurate, portable, durable and cost efficient. There will be an increased ability to drill deeply into steel, or run screws into steel or other materials that require drilling or screwing in places that may be difficult to reach or curved work spaces such as pipes. These improvements can be accomplished while simultaneously reducing the amount of time and labor required by the usage of conventional tools currently available on the market.

Conventional drilling methods require the user to hold the power drill with both hands. This method presents a number of problems when drilling, for example, in doorways, window frames, or near pipes. Conventional drilling in high spaces such as doorways or overhead beams requires the user to devise a scaffold or stand on a ladder, a costly and time-consuming practice that also risks injury to the worker, particularly when both hands are required to hold and guide the drill, and exert an enormous amount of bodily pressure in order to complete the drilling process. Alternately, previous inventions in the field require the use of a manual or foot operated lever, limiting the operator's ability to view the drilling process. Hand-held drilling in window frames or near pipe assemblies is difficult to do accurately, as the worker may be required to hold the drill at an awkward angle. Drilling deep into steel using a hand-held drill typically leads to excessive wear and tear on the drill bit, as well as fatigue and decreased accuracy on the part of the worker. Construction workers frequently encounter all of these concerns within a single drilling task, and there is need in the field for a single device, which allows the worker to address and correct the problems.

The following patents describe various attachments and support mechanisms for portable drills.

U.S. Pat. No. 2,468,358 issued to Francis E. Clark on Apr. 26, 1949, describes a Power Drill Holder. Unlike the present invention, Clark's device employs a clamp mechanism used for securing the power drill holder to the drilling surface. This mechanism limits the use of the power drill holder to drilling those surfaces, which are of the proper size, shape, location, and material to have the device secured to them.

Furthermore, Clark's device does not show a means for securing the drill to a curved work surface or for drilling deep into a surface such as steel, wood, concrete, or other hard metal surfaces. The patent issued to Francis E. Clark is not a Power Drill Assembly and does not claim an actual power drill as its invention. Clark's invention is as stated, a “ . . . tool holder . . . ”. Clark's invention does not claim an improved, electric, hand drill with gear mechanism, because its function is “ . . . holding power drills . . . ” thus proving he does not claim a power drill as his invention, and cannot use the invention alone to drill into an overhead, cylindrical or difficult to reach workplace. An improved electric, hand drill with gear mechanism is claimed as the present invention.

Clark's invention does not claim an extendable rod assembly, because the column (1) does not consist of 2 or more rods that work together and extend to additional heights, but one column of a fixed height. Clark's invention claims a column (1) of a fixed height, therefore preventing the claimed invention to consist of an extendable rod assembly upon where a perpendicular brace is attached.

Clark's invention does not claim a perpendicular brace fixed by means of a second clamping mechanism, because reference character (4) in FIG. 1 designates different elements (screws). In FIG. 1, reference character (2) designates a clamp attached to a flat I-Beam, therefore preventing Clark's invention to consist of a pipe clamp. Clark's invention is limited to flat surfaces and cannot attach to cylindrical surfaces such as a pipe. Clark's invention does not consist of a pipe clamp (9) and a drill brace (9) as the reference character (9) cannot designate different elements. The present invention does claim an extendable rod assembly, a perpendicular brace, a second clamping mechanism and a pipe clamp.

U.S. Pat. No. 4,010,943, issued to Sheldon E. Eft on Mar. 8, 1977, describes a Power Drill Support and Guide Apparatus. Unlike the present invention, the use of Eft's device is limited to those work surfaces, such as beams or other surfaces with free edges, to which the device may be clamped. Furthermore, Eft's device does not show a clamping mechanism that may by solidly secured to a curved drilling surface such as a pipe, or a mechanism that allows drilling deep into a work surface.

U.S. Pat. No. 4,442,905 issued to Edward E. Agoston on Apr. 17, 1984, describes a Jig Assembly for Drilling Vertically Upward. Unlike the present invention, Agoston's device is limited to drilling an overhead surface and does not show a means for supporting a drill in a horizontal position. Furthermore, Agoston's device employs a manual raising lever, which must be operated from below, limiting the operator's ability to view the drilling process in an overhead drilling activity. Finally, the device does not show a mechanism for drilling into pipe or other curved work surface, nor does it show a mechanism for drilling deep into a work surface.

U.S. Pat. No. 4,736,804, issued to Jeffery B. Geibel on Apr. 12, 1988, describes an Overhead Drill Jig. Unlike the present invention, Geibel's device is limited to drilling an overhead surface. Furthermore, it employs a foot pedal, requiring the operator to stand on the floor beneath the drilling surface in order to use the device. Geibel's device prevents the operator from viewing the drilling activity properly in order to make the necessary adjustments. Furthermore, it does not show a means for securing the drill and drilling into a pipe or other curved work surface, nor does it show a means for drilling any surface other than a horizontal overhead work surface.

U.S. Pat. No. 5,295,620, issued to B. Robert Cousineau on Mar. 22, 1994, describes an Extendable Arm for Power Impact Tools. Unlike the present invention, it is limited to drilling into ceilings and employs a foot pedal, requiring the operator to stand on the floor beneath the drilling surface. Furthermore, it does not show a means for securing the drill and drilling into pipe or other curved work surface, nor does it show a means for drilling any surface other than a horizontal overhead work surface.

U.S. Pat. No. 5,322,397, issued to James C. Spear on Jun. 21, 1994, describes an Apparatus for Supporting a Drill in an Elevated Position. Unlike the present invention, it is limited to drilling into ceilings and employs two manual adjustment arms. Furthermore, the drill is not secured directly to the vertical structure of the apparatus, as it is in the present invention. Finally, it does not show a means for drilling any surface other than a horizontal overhead work surface.

U.S. Pat. No. 2,463,691, issued to August F. Habenicht, on Mar. 8, 1949, describes a Power Tool Support. Unlike the present invention, Habenicht's device is limited to drilling vertically downward, into surfaces, which are of the proper size, shape, and location. The use of the Power Tool Support is also limited to a surface on which the base can be placed upon and stand vertically. Furthermore, it employs a clamp to provide an opening for a tubular handle of a drill and serves only as a temporary support for drilling, unlike the present invention, which comprises an improved power driven drill with gear mechanism that can be used in conjunction with an extendable rod. Unlike the present invention, Habenicht's device does not claim to comprise an extendable rod assembly consisting of a first and second column, each with an upper and lower end, where the lower end of the second column is inserted into the upper end of the first column and fixed within the first column by means of a first clamping mechanism at the upper end of the first column, to form a rod of varying lengths. Unlike the present invention, Habenicht's invention does not show a rod of varying lengths upon which an improved, electric, hand drill with gear mechanism is adjustable to, and it is limited to drilling surfaces which are of the proper size, shape and location. Habenicht's invention is clearly stated a “Power Tool Support” and only provides a means to support an electric drill or power tool, unlike the present invention, that comprises an improved, electric, hand drill with gear mechanism that is used in conjunction with an extendable rod and/or attachments such as a perpendicular brace, pipe clamp, drill brace, and drill clamp that allows drilling to occur in a horizontal, vertical or hard to reach surface, as well as allows drilling into a pipe or cylindrical or curved surface and drilling deep into a work surface. Habenicht's “Power Tool Support” does not describe or show a gear mechanism located inside the power tool, unlike the present invention, which identifies a gear mechanism attached in a perpendicular relation to the improved, electric, hand drill that is designed to extend the drill in a forward motion to move the drill towards a desired drilling surface, advanced by pulling the lever attached to the gear mechanism. Furthermore, Habenicht's “Power Tool Support” does not comprise a unit consisting of an improved, electric, hand drill with bolted gear mechanism and lever that is clamped onto the second column by a third clamping mechanism. Unlike the present invention, Habenicht's “Power Tool Support” does not comprise a third clamping mechanism that is adjustable to the middle of the second column. Unlike the present invention, Habenicht's “Power Tool Support” does not show a perpendicular brace that may be fixed near the outer end of the second column by means of a second clamping mechanism. Unlike the present invention, Habenicht's “Power Tool Support” does not comprise a pipe clamp where one end of the pipe clamp is attached to the extendable rod assembly. Unlike the present invention, Habenicht's “Power Tool Support” does not comprise a pipe clamp to further assist the operator in drilling into cylindrical surfaces. Unlike the present invention, Habenicht's “Power Tool Support” does not comprise a drill brace where one end of the drill brace is attached to the extendable rod assembly. Unlike the present invention, Habenicht's “Power Tool Support” does not comprise a drill brace with a first, second and third bar that may be attached to the second column of the extendable rod assembly to further assist the operator with drilling into difficult to reach or close spaces. Unlike the present invention, Habenicht's “Power Tool Support” does not comprise a drill clamp where the drill clamp is attached to the extendable rod assembly. Unlike the present invention, Habenicht's “Power Tool Support” does not comprise a drill clamp that creates a flat surface to brace against a desired drilling surface, enabling the drill clamp to stay clamped tightly to the drilling material. Unlike the present invention, Habenicht's “Power Tool Support” does not comprise a drill clamp with a first, second and third bar. Habenicht's device does not show an improved drill with gear mechanism with means for securing the drill and drilling into a pipe or other curved work surface, nor does it show a means for drilling deep into a surface such as steel, wood, concrete, or other hard metal surfaces. Habenicht's device is only a support for a drilling machine, unlike the present invention that is an improved, electric, hand drill with gear mechanism that is used in conjunction with an extendable rod and attachments.

U.S. Pat. No. 5,676,503, issued to Armand Lang on Oct. 14, 1997, describes a Drill Stand With An Automatic Advancement Device For A Drilling Machine. Unlike the present invention, Lang's invention relates to a drill stand, for a drilling machine. Unlike the present invention, Lang's device does not comprise an improved, electric, hand drill with gear mechanism. Unlike the present invention, Lang's device does not comprise an improved, electric, hand drill with gear mechanism that can be attached to an extendable rod assembly and advanced towards a drilling surface by pulling a lever on the gear mechanism once the extendable rod assembly is fixed by a first clamping mechanism. Lang's device is raised via a compression advancement spring and requires the operator to brace each end of the drill stand against the surface of the drilling site, limiting the use of Lang's device to those work spaces such as ceilings or vertical walls. Unlike the present invention, Lang's device employs two adjustment heads with a rotatable friction roller to compress the advancement spring, and does not comprise an extendable rod assembly, nor a means for maintaining the length of an extendable rod assembly by tightening a first clamping mechanism. Lang's device does not claim an extendable rod assembly with a first clamping mechanism. Lang's invention does not claim to comprise a first clamping mechanism to fix a second column within a first column. The present invention does claim an extendable rod assembly with a first and second column, each with an upper and lower end where the lower end of the second column is inserted into the upper end of the first column and fixed within the first column by means of a first clamping mechanism at the upper end of the first column. Furthermore, Lang's device is switched on via remote control, limiting the control of the device by the operator. Finally, Lang's device does not show a means for drilling into pipe or other curved work surface, nor does it show a means for solidly securing the drill to a curved work surface, or for drilling deep into a work surface. Lang's device is only a support for a drilling machine, unlike the present invention that is an improved, electric, hand drill with gear mechanism that is used in conjunction with an extendable rod and attachments.

U.S. Pat. No. 2,672,770 issued to E. W. Buck does not claim an electric, hand drill (30), because Buck's invention claims only “ . . . a support for an electric drill . . . ”. Buck's invention does not claim a gear mechanism as part of an electric hand drill, because an electric hand drill is not claimed as the invention. The present invention does claim an “ . . . electric, hand drill with gear mechanism . . . ”.

Other patents related to the present invention are U.S. Pat. No. 1,922,532, issued to Harry H. Ehlen on Aug. 15, 1933; U.S. Pat. No. 2,405,110, issued to James Bullock on Aug. 6, 1946; U.S. Pat. No. 2,643,088, issued to John Hornack on Jun. 23, 1953; U.S. Pat. No. 2,720,125, issued to Donald R. Palik, issued Oct. 11, 1955; U.S. Pat. No. 3,060,769, issued to Merle J. Heider on Oct. 30, 1962; U.S. Pat. No. 4,494,895, issued to Arthur J. Leaf on Jan. 22, 1985; U.S. Pat. No. 4,576,529, issued to Hans Forrer on Mar. 18, 1986; U.S. Pat. No. 288,405, issued to Leo Klapperich on Feb. 24, 1987; U.S. Pat. No. 5,230,496, issued to Richard A. Shillington et al. on Jul. 27,1993; U.S. Pat. No. 5,244,048, issued to Ehtan W. Moorhead, Sr., on Sep. 14,1993; and U.S. Pat. No. 5,634,619, issued to Carlo Alessi on Jun. 3, 1997.

A need has been established for an invention such as the one presented which provides a portable drilling assembly used to support and guide a portable improved, electric, hand drill with gear mechanism that can drill through various surfaces and run screws. This invention provides a portable drilling assembly, of the character set forth above, which is supported on the floor and extendable up to a drilling height of twelve (12) feet, allowing the operator to brace the assembly against an overhead surface for added stability and accuracy. This invention can be used to provide a portable drilling assembly, of the character set forth above, that may also be used in conjunction with a pipe clamp in order to affix the assembly to a pipe set at any angle and drill into the pipe. This invention may also be used in conjunction with a drill brace in order to accurately support the improved, electric, hand drill with gear mechanism in close spaces or may be used in conjunction with a drill clamp in order to accurately drill into deep surfaces. This device also provides a portable drilling assembly, of the character described above that has the capacity to combine any or all of the features listed herein. A further use of this invention is to provide a portable drilling assembly which can also run screws, of the character listed above, that when used alone or in conjunction with a pipe clamp, drill brace, or drill clamp feature, will further reduce the time and physical energy required by conventional drills on the market.

### SUMMARY OF THE INVENTION

The present invention is a portable drilling assembly with an extendable rod, where the extendable rod is made up of two columns, one fitting within the other, with a mechanism for adjusting and fixing the column to form a rod of varying lengths. The extendable rod is attached to the improved, electric, hand drill with gear mechanism and a brace at one end of the inner column. It also has a bracing disk at one end of the outer column. Another part of the present invention is a separate pipe clamp that can be attached to the extendable rod and fixed to a pipe or other cylindrical drilling surface. Furthermore, this invention includes a separate drill brace that can be attached to the extendable rod in conjunction with the pipe clamp, if necessary. Finally, this invention includes a separate drill clamp that can be attached to the extendable rod in conjunction with the pipe clamp in necessary, or with the drill clamp if necessary, or with both.

### BRIEF DESCRIPTION OF THE DRAWINGS

FIG. 1 shows a view of the extendable rod and the improved, electric, hand drill with gear mechanism of the present invention.

FIG. 2 shows a view of the pipe clamp, and the improved, electric, hand drill with gear mechanism of the present invention.

FIG. 3 shows a view of the drill brace and the improved, electric, hand drill with gear mechanism of the present invention.

FIG. 4 shows a view of the drill clamp and the improved, electric, hand drill with gear mechanism of the present invention.

### DETAILED DESCRIPTION OF THE INVENTION

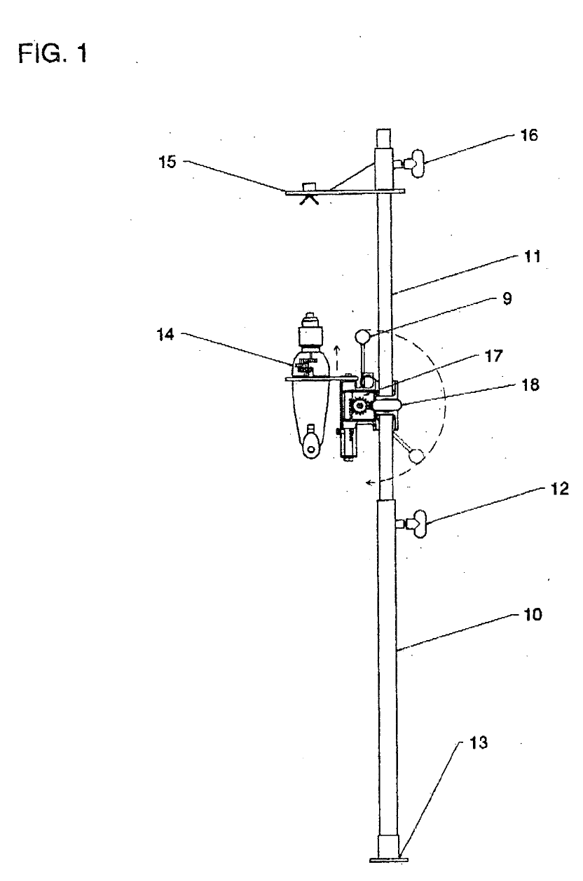

Referring more specifically to FIGS. 1-4, the invention is there exemplified in a novel Universal Pressure Drill and Screw Runner designed for floor-supported drilling into overhead work surfaces, as well as for drilling into pipe, drilling in small work spaces, and/or drilling deep into steel, wood, concrete, and other hard metal surfaces as well as run screws. The various components of the invention are designed to be used separately, or in conjunction to perform safe, accurate, labor-efficient and cost-effective drilling in a variety of drilling surfaces and workspaces.

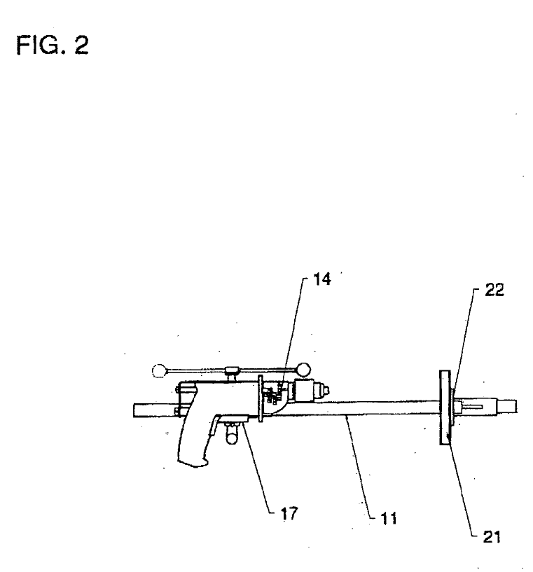

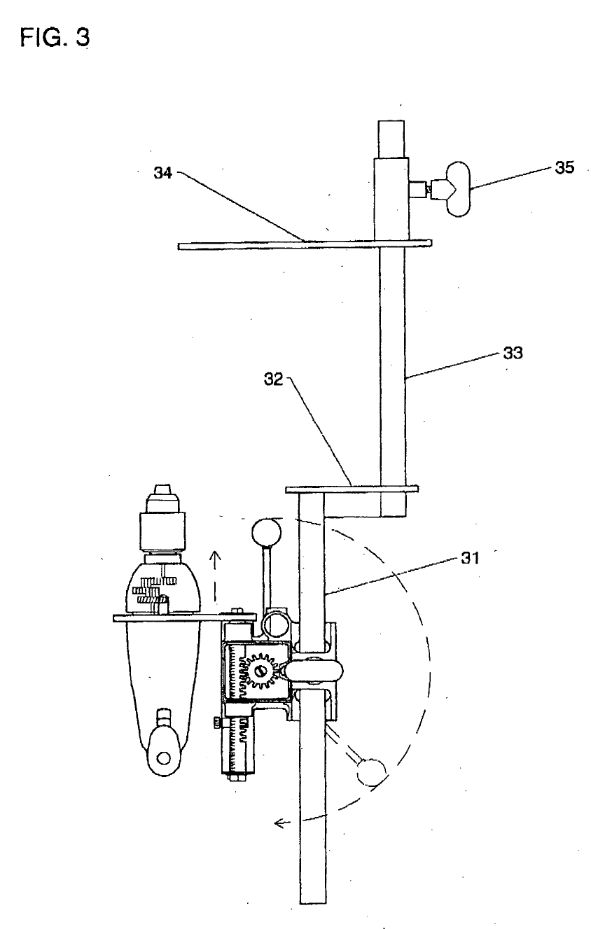

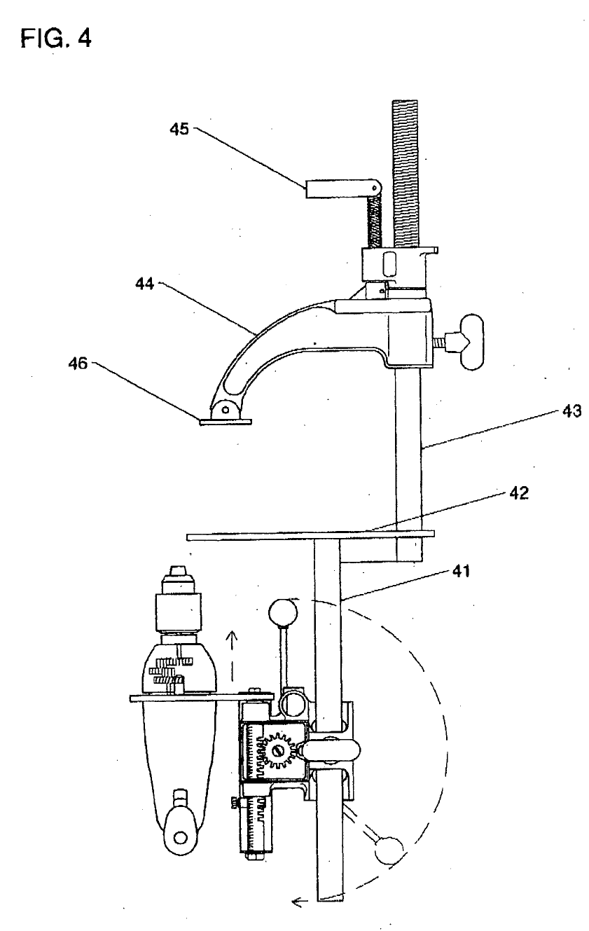

In accordance with the invention, the Universal Pressure Drill comprises an extendable rod with the improved, electric, hand drill with gear mechanism (FIG. 1), a pipe clamp with the improved, electric, hand drill with gear mechanism (FIG. 2), a drill brace with the improved, electric, hand drill with gear mechanism (FIG. 3), and a drill clamp with the improved, electric, hand drill with gear mechanism (FIG. 4).

Referring more specifically to the extendable rod (FIG. 1), the structure comprises a first column (10), a second column (11), which fits within the first column (10), a first clamping mechanism (12) for adjusting and fixing the first column (10) and the second column (11) to form an extendable rod of varying length. At the outer end of the first column (10) is a removable perpendicular bracing disk (13) used for steadying the extendable rod against the floor or other work area. In the middle portion of the second column (11) closest to the first clamping mechanism (12) is an improved, electric, hand drill (14). The improved, electric, hand drill (14) is bolted and lies in a perpendicular relation to a gear mechanism (17), which is attached in a parallel relation to the lever (9) forming one unit. The gear mechanism (17) is designed to extend the drill in a forward motion to move the drill motor towards a desired drilling surface, advanced by pulling the lever (9) attached to the gear mechanism (17), so that the distance between the drill motor and a drilling surface is decreased. The gear mechanism (17) is clamped onto the second column (11) by a third clamping mechanism (18) allowing the improved, electric, hand drill (14) with gear mechanism (17), to be moved up and down to adjust the height. A perpendicular brace (15) may be fixed near the outer end of the second column (11) by means of a second clamping mechanism (16).

The extendable rod may be adjusted longitudinally to lengths between 3′2″ and 7′8″. Such adjustment takes place by maintaining the second column (11) in sliding engagement with the first column (10) and fixing the two columns (10),(11) at a given length by tightening the first clamping mechanism (12). The perpendicular brace (15) may be fixed at the outer end of the second column (11) by tightening the second clamping mechanism (16) and removed by loosening the second clamping mechanism (16) and lifting the detachable brace (15) off the outer end of the second column (11). By adjusting the extendable rod to the appropriate height or length for the work space and by steadying it against an opposite surface using the perpendicular bracing disk (13), the operator may plug the power drill (14) into a wall outlet (not shown) and drill into overhead or difficult to reach surfaces.

The pipe clamp (FIG. 2) may be attached to the extendable rod to further assist the operator in drilling into pipe or other cylindrical surfaces. The pipe clamp comprises a narrow clamping surface (21), and a wide clamping surface (22). The narrow clamping surface (21) lies perpendicular and is fixed to the wide clamping surface (22). By securing the wide clamping surface (22) around the diameter of a pipe as shown, or other cylindrical drilling surface, and by further securing the narrow clamping surface (21) to the outer end of the second column (11) of the extendable rod (FIG. 1), the operator may secure the improved, electric, hand drill (14) with gear mechanism (17) in a position that allows for straight, accurate drilling into the pipe.

The drill brace (FIG. 3) may be attached to the improved, electric, hand drill with gear mechanism to further assist the operator with drilling in areas that require greater depth, and drilling into difficult to reach or close spaces. The drill brace comprises a first bar (31) a second bar (32) which is shorter than the first bar (31), a third bar (33) which is approximately equal in length to the first bar (31), a fourth bar (34), and a curved clamping mechanism (35). The first bar (31) and the second bar (32) are affixed to each other at one end in a perpendicular fashion to form an “L” shape. The third bar (33) is affixed to the opposite end of the second bar (32) in a perpendicular fashion but in an opposite direction in a longitudinal plane from the first bar (31), so that the first bar (31) and the third bar (33) lie parallel to each other. The fourth bar (34) is affixed to the third bar (33) in a perpendicular fashion to form a “T” shape, such that the second bar (32) and the fourth bar (34) protrude from the third bar (33) parallel to each other and in the same direction. The curved clamping mechanism (35) is affixed to the third bar (33) at the same point as the fourth bar (34) but facing in the opposite direction.

The drill clamp (FIG. 4) creates a flat surface to brace against desired drilling surface, enabling the drill clamp to stay clamped tightly to drilling material. The drill clamp comprises a first bar (41), attached in perpendicular relation to a second bar (42), a third bar (43) attached in perpendicular relation to one end of the second bar (42) where the third bar (43) protrudes from the second bar (42) in an opposite parallel direction from the first bar (41). A curved brace mechanism (44) fits in sliding relation over the third bar (43) and is secured there by means of a releasable clamping mechanism (45), such that the bracing surface (46) of the curved brace mechanism (44) faces parallel to the second bar (42).

1. An improved, electric, hand drill with gear mechanism for drilling in an overhead, cylindrical or difficult to reach workplace, an extendable rod assembly of a first column, a second column wherein said second column fits within said first column, a first clamping mechanism for adjusting and fixing said first and said second column, a third clamping mechanism for adjusting and fixing said improved, electric, hand drill with gear mechanism to said second column, a perpendicular brace, a second clamping mechanism for adjusting and fixing said perpendicular brace to said second column, a removable bracing disc for steadying said first column against a floor or other work area.

2. An improved, electric, hand drill with gear mechanism for drilling in an overhead, cylindrical or difficult to reach workplace, a second column, a third clamping mechanism for adjusting and fixing said improved, electric, hand drill with gear mechanism to said second column, a pipe clamp of a narrow clamping surface and a wide clamping surface wherein said narrow clamping surface lies parallel and is fixed to said wide clamping surface, a second clamping mechanism for adjusting and fixing said pipe clamp to said second column.

3. A improved, electric, hand drill with gear mechanism for drilling in an overhead, cylindrical or difficult to reach workplace, a drill brace of a first bar, a second bar fixed in a perpendicular fashion to said first bar to form an “L” shape, a third bar fixed to said second bar in a perpendicular fashion but in an opposite direction in a longitudinal plane from said first bar, a fourth bar, a curved clamping mechanism for adjusting and fixing said fourth bar to said third bar, a third clamping mechanism for adjusting and fixing said improved, electric, hand drill with gear mechanism to said first bar.

4. An improved, electric, hand drill with gear mechanism for drilling in an overhead, cylindrical or difficult to reach workplace, a drill clamp of a first bar, a second bar fixed in a perpendicular fashion to said first bar, a third bar fixed in a perpendicular fashion but in an opposite direction in a longitudinal plane from said first bar, a curved brace mechanism, a releasable clamping mechanism for adjusting and fixing said curved brace mechanism to said third bar, a bracing surface fixed to said curved brace mechanism and lying parallel to said second bar, a third clamping mechanism for adjusting and fixing improved, electric, hand drill with gear mechanism to said first bar.
